(19) United States
(12) Patent Application Publication
(10) Pub. No.: US 2026/0244625 A1
(43) Pub. Date: Aug. 20, 2026

(54) ENHANCED RETRIEVAL OF STRUCTURED DATA IN FULFILLMENT PROCESSES WITH ONTOLOGY-BASED KNOWLEDGE GRAPHS

(71) Applicant: Target Brands, Inc., Minneapolis, MN (US)

(72) Inventors: Mengyue Zhao, Minneapolis, MN (US); Matthew Nokleby, Minneapolis, MN (US); Bo Shen, South San Francisco, CA (US)

(73) Assignee: Target Brands, Inc., Minneapolis, MN (US)

(21) Appl. No.: 19/543,239

(22) Filed: Feb. 18, 2026

Related U.S. Application Data
(60) Provisional application No. 63/759,572, filed on Feb. 18, 2025.

(51) Int. Cl. G06F 16/2455; G06F 16/242; G06F 16/2452

(52) U.S. Cl. CPC G06F 16/24565; G06F 16/243; G06F 16/24522; G06F 16/24524; G06F 16/24556; G06F 16/2456

(57) ABSTRACT

Systems and methods for enhanced information retrieval in retail fulfillment operations are provided. An ontology-based knowledge graph is integrated with structured query generation for submission to a large language model. Multi-hop queries across varied data sources are performed while maintaining high accuracy and precision. In examples, a three-stage query processing pipeline generates ontology-aligned queries, performs relationship mismatch resolution, and validates attribute references. This structured approach enables precise traversal of object relationships and systematic data aggregation.

### CROSS-REFERENCE TO RELATED APPLICATIONS

This application claims priority to U.S. Provisional Patent Application Ser. No. 63/759,572 filed on Feb. 18, 2025, the disclosure of which is hereby incorporated by reference in its entirety.

### BACKGROUND

Retail fulfillment involves interlinked data sources (e.g., purchase orders, shipping records, inventory, worklist logs, and the like) that must be integrated to allow for decision-making in essential fulfillment operations. Traditional retrieval methods struggle with queries requiring structured reasoning and data retrieval from multiple sources (e.g., “multi-hop queries”), such as linking orders to fulfillment actions or tracking shipments across locations. For example, traditional retrieval methods may result in Cartesian product errors, table join misspecifications, and other inconsistencies which may lead to critical failures in time-sensitive fulfillment operations.

While LLMs and hybrid search methods can handle simple data retrieval and presentation, they often fail in responding to multi-hop queries which demand precise object relationships and systematic aggregation of data points (e.g. linking orders to specific fulfillment actions, determining the number of worklists for a specific product type completed within a timeframe at multiple locations, or even more complex queries.)

Additionally, while recent advancements in Text-to-SQL and GraphRAG provide structured retrieval via relational queries or embeddings, they may still fail to retrieve accurate results in response to multi-hop queries of increasing levels of complexity. For example, Text-to-SQL operates within a fixed schema, lacking multi-relational modeling and GraphRAG prioritizes embedding-based retrieval over explicit multi-hop execution. Accordingly, improvements in technology are desirable in situations where explicit, relational traversal is essential.

### SUMMARY

In accordance with aspects of this disclosure, systems for enhanced information retrieval in retail fulfillment operations are provided. An ontology-based knowledge graph is integrated with structured query generation for submission to a large language model. Multi-hop queries across varied data sources are performed while maintaining high accuracy and precision. In examples, a three-stage query processing pipeline generates ontology-aligned queries, performs relationship mismatch resolution, and validates attribute references. This structured approach enables precise traversal of object relationships and systematic data aggregation.

In accordance with a first aspect of the disclosure, a computer-implemented method is provided for multi-hop retrieval of structured relational data. The method includes receiving a natural language query from a requesting entity and accessing a graph-based data structure representing a plurality of structured datasets obtained from a plurality of data sources. The graph-based data structure is defined according to an ontology specifying a plurality of entity types corresponding to structured data entities and a plurality of relationship types defining permitted relationships between the entity types. The method further includes generating, using a machine learning model guided by the ontology, a structured graph traversal query configured to traverse a plurality of nodes of the graph-based data structure according to one or more relationships defined by the ontology. The structured graph traversal query is validated prior to execution, and, when validation indicates that the traversal query violates at least one ontology-defined constraint, the traversal query is modified. The validated structured graph traversal query is executed to perform a multi-hop traversal across two or more structured datasets and to compute an aggregated result, and a response corresponding to the aggregated result is transmitted to the requesting entity.

In accordance with a second aspect of the disclosure, a system is provided for ontology-guided retrieval of structured data. The system includes one or more processors and one or more memory devices storing instructions that, when executed by the one or more processors, cause the system to receive a natural language query and access a graph-based data structure representing a plurality of structured datasets. The graph-based data structure is organized according to an ontology defining entity types, relationship types, and traversal constraints governing multi-hop traversal across the structured datasets. The system further applies a machine learning model to generate a structured graph traversal query from the natural language query, the structured graph traversal query being constrained by the ontology to enforce valid multi-hop relationships between structured datasets. The system executes the structured graph traversal query to retrieve data spanning multiple structured datasets and to produce an aggregated output.

In accordance with a third aspect of the disclosure, a structured data retrieval system is provided for retrieving structured store fulfillment data within a retail enterprise. The system includes a computing system having one or more processors and one or more memory devices storing instructions that, when executed, cause the computing system to receive a natural language query from a requesting entity and access a graph-based data structure representing a plurality of structured datasets obtained from a plurality of enterprise data sources. The graph-based data structure is organized according to an ontology defining entity types, relationship types, and traversal constraints governing multi-hop traversal across the structured datasets. The structured data retrieval system further generates, using a machine learning model guided by the ontology, a structured graph traversal query configured to traverse a plurality of nodes of the graph-based data structure according to one or more ontology-defined relationships. The structured graph traversal query is validated prior to execution to determine whether the traversal query violates at least one ontology-defined constraint, and the structured graph traversal query is modified when such a violation is detected. The validated structured graph traversal query is executed to perform a multi-hop traversal across two or more structured datasets and to compute an aggregated result, and a response corresponding to the aggregated result is transmitted to the requesting entity.

### BRIEF DESCRIPTION OF THE DRAWINGS

FIG. 1 illustrates an example network environment in which aspects of the present disclosure may be implemented.

FIG. 2 illustrates a schematic diagram of performing multi-hop retrieval of structured data without a knowledge graph.

FIG. 3 illustrates another schematic diagram of performing multi-hop retrieval of structured data without a knowledge graph.

FIG. 4 illustrates a schematic diagram of an example graph database configured to represent a plurality of structured datasets.

FIG. 5 illustrates a schematic diagram of example components of a structured data retrieval pipeline.

FIG. 6 is a flowchart of an example method for multi-hop retrieval of relational structured data.

FIG. 7 is a flowchart of an example method of generating a structured cypher query for multi-hop retrieval of relational structured data using an LLM.

FIG. 8 is a block diagram of an example computing system with which aspects of the present disclosure may be implemented.

### DETAILED DESCRIPTION

As briefly described above, embodiments of the present invention are directed to systems and methods for enhanced information retrieval in retail fulfillment operations through an ontology-based knowledge graph approach integrated with relational, structured query generation. The systems and methods described herein uniquely address the technical challenge of processing complex multi-hop queries across varied, structured data sources while maintaining high accuracy and precision regardless of the number of data structured sources such must be traversed to acquire an answer.

For example, when acquiring information from multiple structured data sources (e.g. tabular data rather than unstructured documents), two structured data sources may need to be joined across one or more common field between the two tables. A single hop (e.g. 1-hop) relates to one such table join. With each structured data source that must be traversed to obtain a piece of data or compile an answer to a query, an additional hop is added (e.g. 2-hops to retrieve relational data across three tables, 3-hops across four tables, etc.) With each increasing n-hop, traditional systems tend to decline in accuracy or may even fail to retrieve the desired data altogether. These failures can be due to a lack of a defined relationship between the data sources, a failure to precisely align non-primary keys across one or more of the data sources, and the like.

Aspects of the present disclosure provide various technical advantages. For example, in answering complex queries of relational data, the system described herein can leverage explicit relationships between structured data sources through the construction of one or more ontology-based knowledge graph and structured, multi-hop, retrieval therefrom which can lead to improved performance over traditional retrieval methods in terms of accuracy, particularly with increasing query complexity. Furthermore, the systems and methods described herein can include an automated, three-stage query processing pipeline that can generate ontology-aligned queries, execute multi-hop retrieval of structured data, and evaluate and refine retrieval performance through error handling and validation mechanisms.

In example implementations, the system includes a graph database having a definable ontology configured to represent a plurality of structured databases. For example, the graph database can include a plurality of nodes corresponding to a data source and a plurality of edges providing precisely aligned, definitional links between such data sources, thereby enabling accurate, structured, real-time, multi-hop retrieval where each n-hop corresponds to a relational join across different data granularities. Transforming fixed table schemas into such a graph ontology ultimately allows for more flexibly and granularly encoding relationships across a complex structural data system. Overall, the structured approach described herein enables precise traversal of structured data sources and systematic data aggregation therefrom, thereby facilitating more accurate, faster decision-making in any industry requiring structured, multi-relational data analysis.

In some aspects, the system incorporates an ontology-guided LLM to generate structured queries of a graph database, through ontology-guided cypher generation which further enables accurate, multi-hop data retrieval in addition to increasing scalability of the overall system (in terms of n-hop data retrieval). For example, the user query, underlying graph ontology, and metadata describing the data source(s) can be presented to an LLM along with prompting to generate ontology-aligned, cypher queries. By incorporating automated, ontology-guided, cypher generation, the overall speed of the system can be significantly improved over traditional querying methods further enabling real-time multi-hop retrieval capabilities.

In some instances, the generated cypher query can then be executed to perform, a structured, relational traversal of the graph database, retrieving data spanning one or more relational join across different data granularities. This systematic traversal and multi-hop data retrieval across a graph data base ultimately provides an accurate, scalable method of querying structured, relational data in response to multi-hop and cross-granular questions over traditional querying methods (e.g. SQL multi-table joins, semantic querying of graph data, and the like). Still further, in terms of accuracy, the system can be even further refined over traditional systems by applying various error handling and correction steps before, during, or after the querying stage.

In some instances, the retrieved data can be directly output to a user interface, in response to a user query, ultimately enabling real-time decision making and more accurate data retrieval over prior user systems which largely rely on time-intensive, error prone querying of underlying data.

Overall, in the retail fulfillment context, by improving multi-hop structured data retrieval, the system ultimately unlocks improved reasoning and operational decision-making potential in downstream fulfillment systems and workflows (e.g. linking orders to fulfillment actions, tracking shipments across locations, and the like). Furthermore, the methodology described herein can be easily generalized to any structured database having a definable ontology.

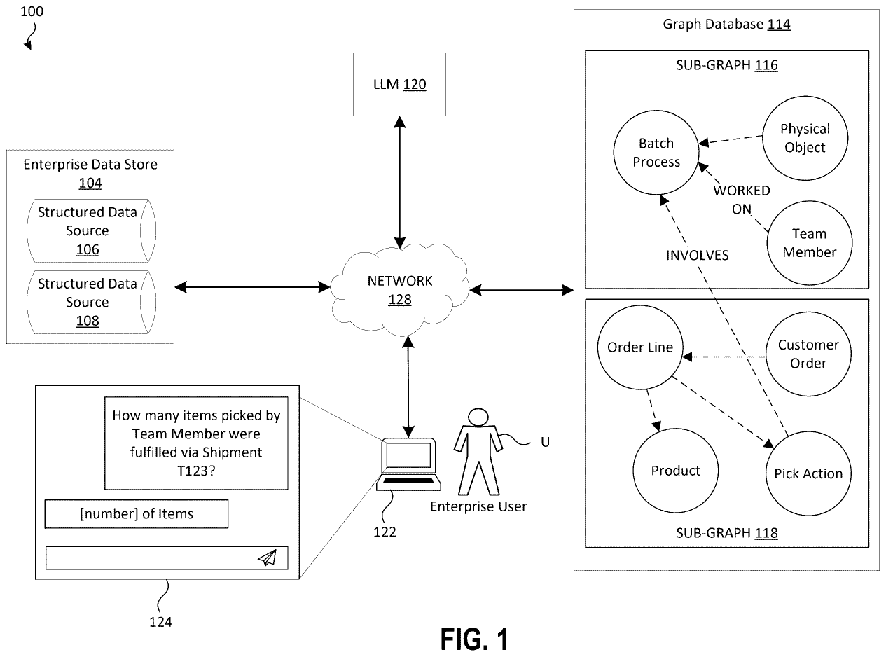

Referring to FIG. 1, an example network environment 100 is shown in which aspects of the present disclosure may be implemented. In the example shown, the network environment 100 includes an enterprise data store 104, a graph database 114, an LLM 120, an electronic computing device 122, a user interface 124, and a network 128. In the example shown, enterprise data store 104 further includes structured data source 106 and structured data source 108. In the example shown, the graph database 114 further includes sub-graph 116 and sub-graph 118. An enterprise user U is also shown.

The enterprise data store 104 is configured to maintain and organize various types of data related to store fulfillment operations. In some examples, a structured data source may also be referred to as a structured data repository. In the retail fulfillment context, structured data repositories can include purchase orders, shipping records, inventory, worklist logs, and the like. The enterprise data store 104 may be managed by the enterprise that hosts the electronic computing device 122 and may comprise one or more database. In implementations, the enterprise data store 104 can include a plurality of interrelated databases that may be integrated for aggregated retrieval. For example, as illustrated in FIG. 1, the enterprise data store 104 can include structured data source 106 and structured data source 108.

In examples, a structured data source (e.g. structured data source 106 and structured data source 108) can include quantitative or qualitative data which is stored in a fixed, predefined format. In further examples, a structured data source can include structured data configured in a tabular format. For example, a structured data source can include one or more spreadsheet or relational database (e.g. SQL databases). In examples, a given structured data source (e.g. structured data source 106 and structured data source 108) can have a given granularity corresponding to the level of detail included in the structured data source. In other examples, the granularity of a structured data source can correspond to the extent to which that data therein is aggregated or disaggregated. For example, each column in a given structured data source can correspond to a level of granularity in describing each record of data recorded in the corresponding rows therein. In some implementations, at least one structured data sources within the enterprise data store 104 can have a granularity which is unique from the other structured data sources within the enterprise data store 104. In other implementations, a plurality of structured data sources within the enterprise data store 104 can have different granularities. In still further implementations, each structured data source within the enterprise data store 104 can have a unique granularity.

In examples, a given structured data source (e.g. structured data source 106 and structured data source 108) can include one or more structured data set, each structured data set having one or more data object (“object”). In examples, an object can correspond to a unique record within a structured data set. In other examples, an object can correspond to an entire row or column within a structured data set. In still other examples, an object can correspond to a partial row or column within a structured data set. For example, an object can include a subset of values within a given row or column within a structured data set. In still further examples, an object can include an intersection between one or more given row or column within a structured data set. In some implementations, an object may also be referred to as an entity or record. In the retail fulfillment context, an object can represent one or more aspect of a purchase order, an inventory item, and the like.

In some examples, two or more structured data sources can have a hierarchical connection. For example, a hierarchical connection can include a hierarchical relationship between a given parent data source and a given child data source. In examples, a given parent data source can have any number of child data sources. In some examples, a given parent data source can also be a child data source of one or more additional “grandparent” data sources. In this manner, hierarchical data structures can include any number of multi-level hierarchical connections. In examples, when retrieving or aggregating data across such hierarchical data sources, it is necessary that such hierarchical connections are properly aligned to prevent data mismatches, filtering inconsistencies, inflation of intermediate results, Cartesian product errors, and other retrieval errors that reduce precision.

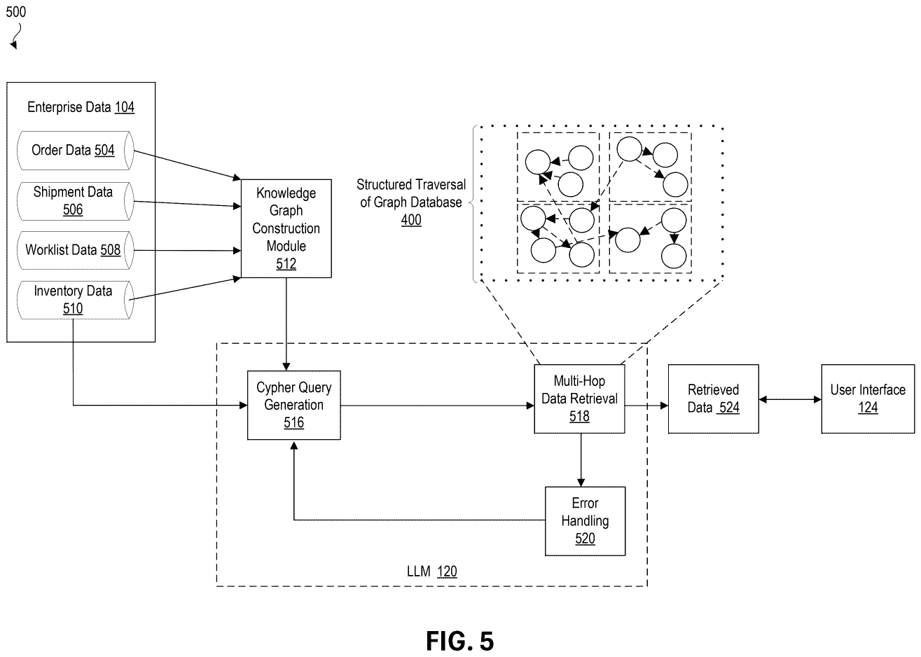

In some examples, a structured data source can have definable attributes or keys which can allow one or more structured data source to be interlinked or aggregated. For example, a given key may be a primary key or a non-primary key. A primary key can serve as unique identifier for each object in a given structured data set. For example, a primary key can uniquely identify each object in a given structured data set. In another example, a given structured data set can include one or more candidate key associated with one or more column within the structured data set. In some implementations, a candidate key which combines two or more columns within a given structured data set may be referred to as a composite key. In examples, any candidate key which uniquely identifies each object within a given structured data set can serve as a primary key. In one example, a non-primary key can be any key that is not selected as the primary key of a given structured data set. In another example, a non-primary key may include any key which does not uniquely identify each object within a given structured data set. In other examples, a non-primary key may include one or more foreign key which is configured to link two separate structured data sets. For example, a given foreign key in a first structured data set may reference the primary key in a second structured data set. In some examples, a foreign key can define a hierarchical relationship between two or more data sets. In one example, a given structured data source can have one primary key and no non-primary keys. In another example, a given data source can have one primary key and at least one non-primary key. In still another example, a given data source can have one primary key and a plurality of non-primary keys. Additional examples of enterprise data and structured data repositories will be further illustrated and described with respect to FIG. 5.

The graph database 114 is configured to maintain one or more graph (e.g. “sub-graphs”). In example implementations, the graph database 114 can be a knowledge graph database, containing one or more knowledge graph. Each sub-graph contained within the graph database 114 is configured to represent one or more structured data source within the enterprise data store 104. As further illustrated and discussed herein, each sub-graph contains at least one node, representing at least one object within a respective structured dataset. In addition, as discussed in further detail below, each sub-graph can include one or more, link, or edge, defining a linking relationship between two or more nodes. In examples, a given edge can define a linking relationship between the two nodes based on a corresponding key therebetween. For example, a given edge can be formed between two nodes based on one or more corresponding key between the respective objects which are represented by the two nodes. In some implementations the graph database 114 can include definitional edges that explicitly define a hierarchical relationship between two data sources. For example, as illustrated in FIG. 1, a “Team Member” node can be connected to a “Batch Process” node via a “worked on” edge. For example, a “worked on” edge can be configured to define any given team member that has worked on a given batch process, or vice versa. In the example illustrated in FIG. 1, the graph database 114 contains sub-graph 116, which represents structured data source 106, and sub-graph 118, which represents structured data source 108.

As briefly discussed above, and further illustrated and described herein, the structured data within the enterprise data store 104 can be represented by one or more knowledge graph within the graph database 114 to improve data retrieval in terms of efficiency, accuracy, and scalability. For example, the structured data source 106 may include worklist data which may be represented by sub-graph 116. Similarly, the structured data source 108 may include customer data which may be represented by sub-graph 118. In examples, the worklist data contained in structured data source 106 and the customer order data contained in structured data source 108 may include at least one interrelated attribute. In this manner, sub-graphs 116 and 118 may be interrelated for retrieval of data across structured data sources 106 and 108.

The large language model (LLM) 120 may be a model that can receive text data and generate a text response. In some embodiments, the large language model 120 includes a neural network, which may use transformers, that can perform natural language processing tasks. The large language model 120 may be trained on an extensive amount of data, enabling it to learn complex patterns in syntax, semantics, and contextual relationships. For example, as further described herein, the LLM 120 can be on trained data received from the enterprise data store 104, one or more ontology parameter of the graph database 114, or a combination thereof. In some embodiments, the large language model 120 includes more than a billion trainable parameters. In some embodiments, the large language model 120 is integrated into a chatbot with which the user may interact via the user interface 124 of the electronic computing device 122. For example, as further described herein, the LLM 120 can be configured to receive a user query and, in response, generate a structured cypher query configured to provide a retrieval path for traversing one or more node within the graph database 114 to obtain an answer to the user query. For example, a structured cypher query generated by the LLM can provide a retrieval path for traversing a subset of nodes within the graph database 114 in a particular order defining a hierarchical alignment between the respective structured datasets represented by the graph database 114. In examples, executing a structured cypher query against the graph database 114 can retrieve an aggregated result across one or more node therein. In further examples, a response can be transmitted, in response to a user query, according to such an aggregated result. In some embodiments, the large language model 120 comprises multiple large language models. In some embodiments, the large language model 120 includes a plurality of different LLMs 120. For example, although a first step described herein may refer to the LLM 120, and a second step described herein may also refer to the LLM 120, such steps may, in fact, be performed by different large language models. Additionally, in some embodiments, multiple different LLMs may be used to perform a single task that refers to the LLM 120. Additional examples and operations of an LLM will be further illustrated and described with respect to FIGS. 5-7.

The electronic computing device 122 is configured to enable an enterprise user (U) to retrieve data from the enterprise data store 104, graph database 114, or both. For example, as further illustrated and described herein, the electronic computing device 122 can be configured to enable an enterprise user to retrieve data from the enterprise data store 104 via the graph database 114. In examples, as further illustrated and described herein, the electronic computing device 122 can be configured to enable an enterprise user to retrieve data from the graph database 114 via the LLM 120. The electronic computing device 122 may include a variety of devices such as a desktop computer, laptop computer, tablet, or mobile phone. Although a single electronic computing device 122 is shown, the network environment 100 can allow a plurality of user electronic computing devices to simultaneously connect to the network 124. As illustrated in FIG. 1, the user electronic computing device 122 can be configured to display a user interface 124.

The user interface 124 is configured to allows an enterprise user to enter a natural language query, display a natural language result in response to a natural language query, or a combination thereof. In examples, the enterprise user can be a requesting entity from which a natural language query is received. In examples, as further illustrated and described herein, a natural language query received from the enterprise user can be provided to the LLM 120. In some examples, the LLM 120 can generate a structured cypher query configured to retrieve an aggregated result from the graph database 114 according to the natural language query received from the enterprise user. In further examples, a response or aggregated result can be transmitted to the enterprise user via the LLM 120 once an aggregated result has been retrieved from the graph database 114. For example, a natural language response containing an aggregated result retrieved from the graph database 114 can be displayed to the enterprise user via the user interface 124.

The network 128 is a computer network, such as a local area network, a wide area network, the Internet, or a mixture thereof. An enterprise user U of the electronic computing device 122 can receive information for display on the user interface 124 of the electronic computing device 122, including structured data within the enterprise data store 104 which is represented by the graph database 114 and queried by the LLM 120, via the network 128. In other examples, the network 128 may include another type of computer network that enables communication between the electronic computing device 122, the enterprise data store 104, the LLM 120, and the graph database 114.

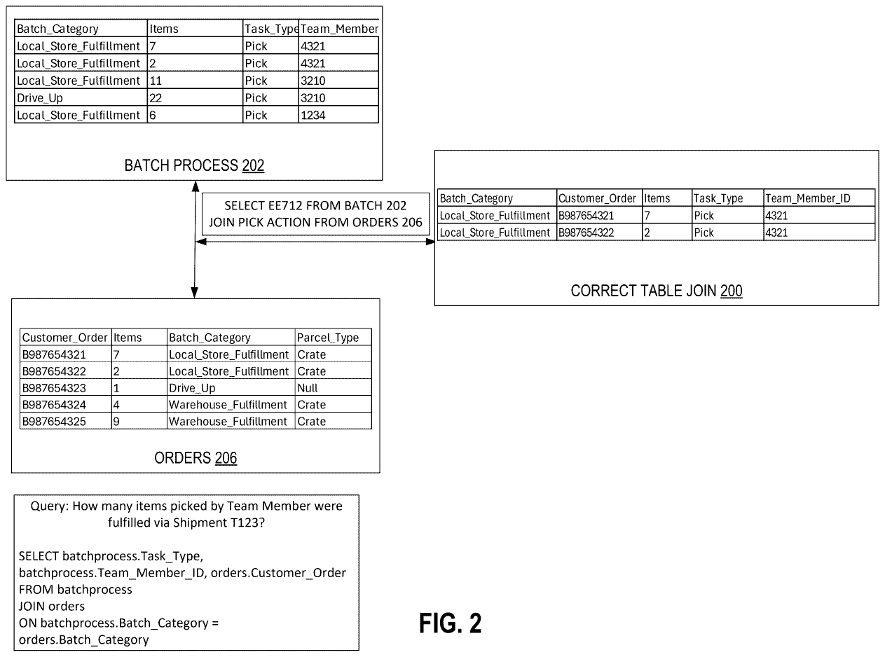

FIG. 2 illustrates a schematic diagram of performing multi-hop retrieval of structured data without a knowledge graph. In the example shown, a requesting entity seeks to find out, “How many items picked by Team Member were shipped to a Minneapolis zip code?” In this example, determining an answer to this query may require traversing multiple, structured databases. In examples where determining an answer to this query requires aggregating data across two or more structured data source, a user must accurately execute two or more properly aligned joins between each respective pair of structured data sources.

For example, a user may first need to determine a series of pick actions executed by a Team Member and which of those pick actions, if any, were related to a fulfillment action (e.g. order fulfillment via a local store, a warehouse, or both). This can require joining a first structured data source related to order data (e.g. Orders 206) with a second structured data source related to fulfillment-related tasks assigned to a given team member, including tasks related to fulfilling a given order (e.g. Batch Process 202). This can require joining a third structured data related to one or more shipment through which a given order delivered to a customer (e.g. Shipment data, not shown). In some examples, a fourth structured data source related to store inventory may also be joined to answer the user query (e.g. Inventory data, not shown).

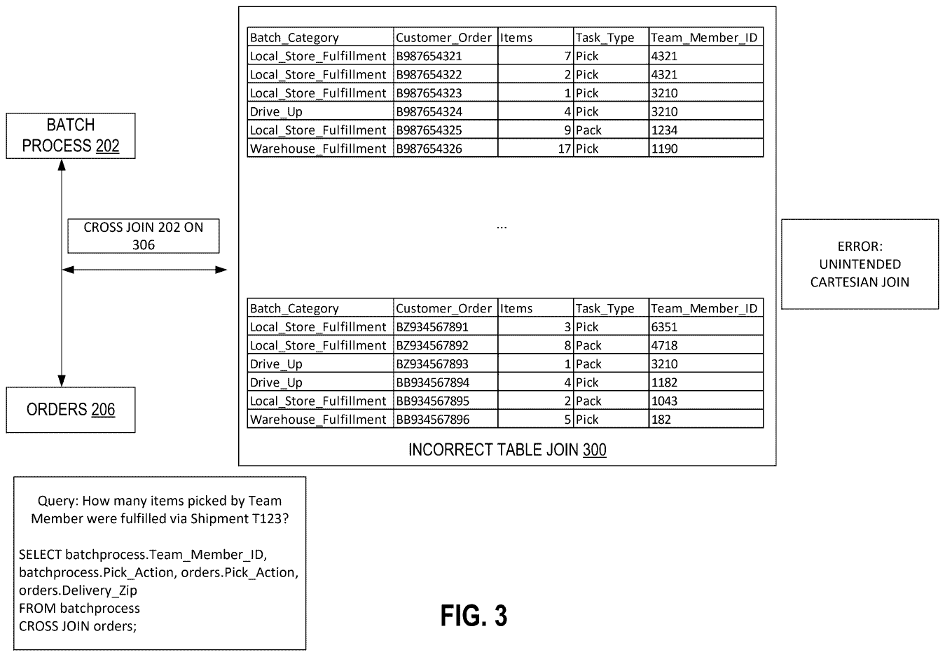

As illustrated in FIG. 2, Batch Process 202 and Orders 206 are correctly joined to provide Correct Table Join 200. In this example a third, shipment data source may now be joined to identify the number of items picked by the team member 4321, included in customer orders B987654321 and B987654322, were fulfilled via Shipment T123. However, as further illustrated in FIG. 3, inaccuracies can easily occur as a result of an erroneous join, data misalignment, and the like, across two or more structured data sources.

FIG. 3 illustrates another schematic diagram of performing multi-hop retrieval of structured data without a knowledge graph. As illustrated in FIG. 3, in response to the same user query provided in FIG. 2 (“How many items picked by Team Member were shipped to a Minneapolis zip code?”) the same two structured data sources, Batch Process 202 and Orders 206, are joined together. However, in this case, the user improperly executes a cross join between the two tables leading to an unintended cartesian join. As illustrated in FIG. 3, such a cartesian join can easily lead to hundreds of thousands of data entries, if not more. Not only are the results of such an incorrect table join not responsive to the user query, they may introduce new inaccuracies, lead to expensive and time intensive resource consumption, and the like.

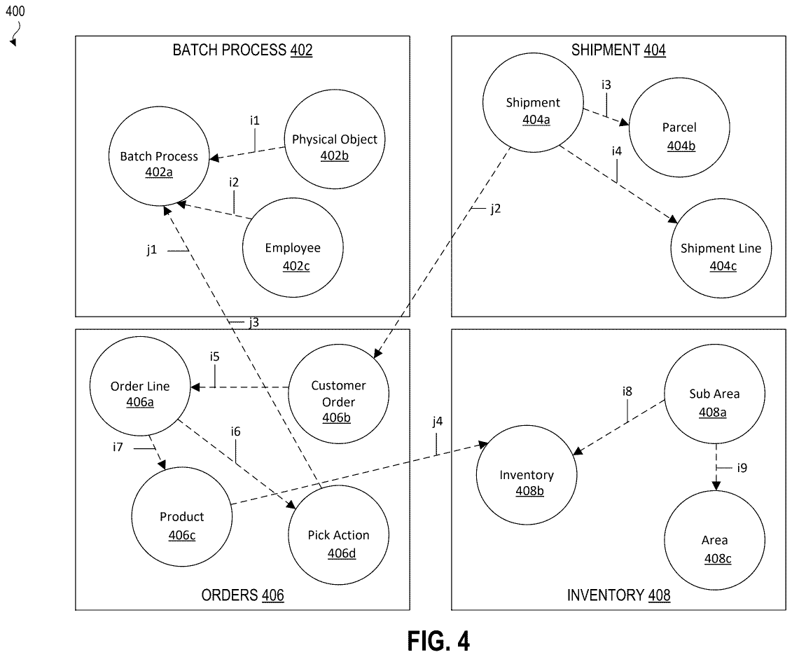

FIG. 4 illustrates a schematic diagram of an example graph database 400 configured to represent a plurality of structured datasets. In the example shown, the graph database 400 includes a plurality of sub-graphs, a plurality of nodes, and a plurality of edges. In the example illustrated in FIG. 4, the plurality of sub-graphs include sub-graphs 402, 404, 406, and 408. Each sub-graph 402, 404, 406, and 408 includes at least one node. For example, sub-graph 402 includes nodes 402a, 402b, and 402c; sub-graph 404 includes nodes 404a, 404b, and 404c; sub-graph 406 includes nodes 406a, 406b, 406c, and 406d; and sub-graph 408 includes nodes 408a, 408b, and 408d. As illustrated in FIG. 4, each node 402a-408d is connected to at least one other node via an edge. For example, a given node can be linked to a separate node within the same sub-graph via an inner table edge. Inner table edges illustrated in FIG. 4 include edges: i1, i2, i3, i4, i5, i6, i7, i8, and i9. As further illustrated in FIG. 4, a given node can be linked to a separate node within a different sub-graph via a joining edge. Joining edges illustrated in FIG. 4 include edges j1, j2, j3, and j4. It is noted that various other edges may exist as well (e.g., between nodes 402a and 404c, 404c and 408a, etc.); however such edges are not depicted here, mainly for graphical simplicity.

In general, each sub-graph 402-408 is configured to represent structured data ingested from one or more given structured data source. In the example illustrated, sub-graph 402 relates to batch process data, sub-graph 404 relates to shipment data, sub-graph 406 relates to order data, and sub-graph 408 relates to inventory data. More or fewer sub-graphs are possible. In examples, the graph database 400 has a defined ontology which specifies the structured relationship of the data contained therein. For example, as further described herein, the graph database 400 can have a definable ontology configured to describe the data represented by a given node, the relationship between respective data sources via edges, and the like. In some implementations, each sub-graph can have a definable ontology based on the intricacies of the data ingested from a given structured data source. For example, the ontology of a given sub-graph can define the data represented by a given node within that sub-graph and encode the relationship between respective pairs of nodes within the sub-graph.

The nodes 402a-408d generally represent at least one object within a given structured data source. Each node 402a-408d is linked to at least one other node via an edge which defines a linking relationship therebetween. In examples, a given edge can define a linking relationship between two nodes based on a corresponding key drawn, upstream, from a given structured data source. That is to say, a given edge can be formed between two nodes based on at least one corresponding key between the respective objects that are represented by the two nodes. In this manner, each edge can provide a precisely aligned, definitional links between two nodes.

In some implementations, a given edge between two nodes can be an inner table edge (e.g. edges i1-19) or a joining edge (e.g. j1-j4). Inner table edges i1-19 provide a path for aggregating data within a single structured data source. Joining edges j1-j4 i9 provide a path for aggregating data across two or more structured data sources. For example, joining edges j1-j4 can represent a structured, relational join between the structured data sets represented by the respective sub-graphs.

As illustrated in FIG. 4, one or more edge can be traversed to aggregate data across one or more data source represented by the sub-graphs 402-408. In this manner, accurate, structured, multi-hop retrieval across different structured data sources, different granularities, or both can be quickly executed. For example, instead of joining two structured data sources via traditional methods, as illustrated in FIGS. 2-3, instead, the graph database 400 can be used to traverse multiple sub-graphs quickly and accurately via precisely aligned edges. For example, structured data can be aggregated across two sub-graphs by traversing a joining edge linking the two sub-graphs. In this example, traversing a single joining edge between two sub-graphs simulates a single hop (e.g. 1-hop) relational join across the structured data sources which are represented by the two sub-graphs. With each sub-graph that is traversed to aggregate a result, an additional hop is added (e.g. 2-hops to aggregate data across three sub-graphs, 3-hops across four sub-graphs, etc.)

By way of illustration, a 0-hop query of the graph database 400 would only require traversal of one or more node within a single sub-graph. For example, a result aggregated across nodes 408a and 408c across inner edge 19 would correspond to a 0-hop query. In another illustrative example, a 1-hop query of the graph database 400 would require traversal of two or more nodes across two sub-graphs. For example, a result aggregated across nodes 406a, 406c, and 408b by traversing edges i7 and j4 would correspond to a 1-hop query. Likewise, a query which requires traversal of joining edges j2 and j4 to aggregate data across nodes 404a, 406b, 406a, 406c, and 408b would correspond to a 2-hop query. As further discussed herein, such aggregated data can ultimately be returned to a user as a single value or a plurality of values.

FIG. 5 illustrates a schematic diagram of example components of a structured data retrieval pipeline 500. In examples, the structured data retrieval pipeline 500 can be configured to retrieve structured store fulfillment data within a retail enterprise. In the example shown, the structured data retrieval pipeline 500 includes enterprise data store 104, knowledge graph construction module 512, LLM 514, cypher query generation 516, multi-hop data retrieval 518, error handling 520, retrieved data 524, and user interface 526. In the example shown, enterprise data store 104 includes order data 504, shipment data 506, worklist data 508, and inventory data 510. Also illustrated is a schematic depiction of graph database 400 and structured traversal thereof.

The enterprise data store 104 is configured to maintain and organize various types of data related to store fulfillment operations. In the retail fulfillment context, structured data repositories can include purchase orders, shipping records, inventory, worklist logs, and the like. In the example illustrated in FIG. 5, the enterprise data store 104 includes order data 504, shipment data 506, worklist data 508, and inventory data 510. In some examples, the data from one or more source within the enterprise data store 104 can be provided to the knowledge graph construction module 512. In some examples, one or more data store within the enterprise data store 104 can include data previously obtained at a given timepoint. In other examples, one or more data source within the enterprise data store 104 contain real-time data that is periodically or continuously refreshed. In examples, the data across the enterprise data store 104 may not be standardized. For example, data from one or more source within the enterprise data store 104 may not have consistent identifiers, defined relationships, or the like. In some examples, a subset of the data within the enterprise data store 104 can be standardized before being provided to the knowledge graph construction module 512. In other examples, all data is standardized before being provided to the knowledge graph construction module 512. In implementations, two or more structured datasets within the enterprise data store 104 may be received from two different data sources have one or more unstandardized identifier. In examples, one or more identifier included within the first and second structured datasets must be standardized prior to providing the data to the knowledge graph construction module 512. In some examples, the data provided to the knowledge graph construction module 512 includes metadata describing the data source, data identifiers therein, relationships between other data sources, and the like.

Knowledge graph construction module 512 is configured to ingest data from the enterprise data store 104 and construct a knowledge graph. In examples, a knowledge graph is constructed according to a definable ontology. For example, the knowledge graph construction module 512 can define a knowledge graph ontology according to the structured relationship of the data received from the enterprise data store 104 across one or more data source. For example, a definable ontology can include node definitions and edge definitions. In examples, a given node definition can be configured to define a respective data sources. In some implementations, a given edge definition can be configured to define a link or relationship between two data sources. In some examples, the knowledge graph ontology can be automatically defined according to metadata describing a given data source, data identifiers therein, and relationships between various data identifiers and data sources. In other examples, the knowledge graph ontology can be defined according to user input received via a user electronic computing device 122.

LLM 120 is configured to receive text data and generate a text response. In examples, the LLM 120 can be on trained data received from the enterprise data store 104, one or more ontology parameter of the graph database 114, or a combination thereof. In embodiments, the LLM 120 can be provided with a natural language request corresponding to a user query provided via the user interface 124, the defined ontology of the graph database 400, metadata describing the data sources within the enterprise data store 104, or a combination thereof. As illustrated, once provided with the defined ontology of the graph database 400, the ontology-guided LLM 120 can execute one or more tasks within the structured data retrieval pipeline 500. For example, the LLM 120 can be configured to perform one or more of cypher query generation 516, multi-hop data retrieval 518, and error handling 520.

Cypher query generation 516 involves translation of a natural language request into a structured cypher query configured to provide a retrieval path of the graph database 400 to obtain an appropriate response. As discussed, a structured cypher query generated by the LLM 120 can provide a retrieval path for traversing a subset of nodes within the graph database 114 in a particular order defining a hierarchical alignment between the respective structured datasets represented by the graph database 400. Said differently, a structured cypher query can be configured to provide a structured retrieval path for traversing one or more node within the graph database 114 to obtain an aggregated result. IIn this manner, the LLM can develop a multi-hop, structured cypher query which can be scaled with increasing n-hop query complexity. n examples, a given structured cypher query can simulate a multi-hop structured data retrieval scenario, wherein each hop corresponds to a relational join across two structured data sources within the enterprise data store 104. By way of comparison, typical embedding search and retrieval methods of standard graph databases, which represent unstructured documents or data, utilize a semantic meaning comparison between a given query and one or more respective nodes to identify a closest result. As such, typical embedding searches cannot perform n-hop data retrieval across different data sources, let alone relational, structured data which requires precise alignment across varying granularities.

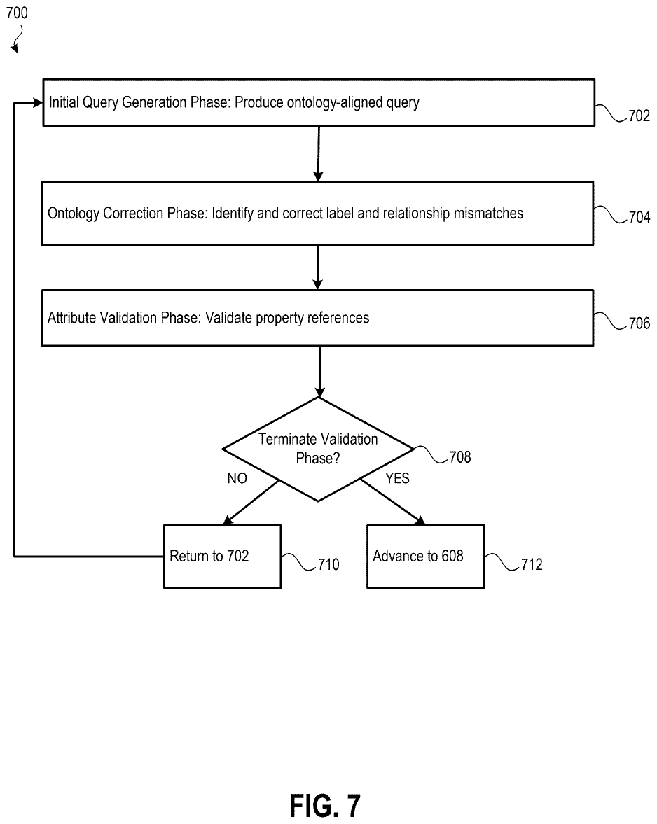

In some examples, cypher query generation 516 involves providing the LLM 120 with a definition of the knowledge graph ontology such that it can recognize a specific, hierarchical relationship between one or more node. In this manner, the LLM 120 can generate a structured cypher query that can traversed to obtain precisely aligned retrieval of structured data. In some implementations cypher query generation 516 further involves providing the LLM 120 foreign and primary key relationships between two or more data sources. In further implementations, cypher query generation 516 can involve providing the LLM 120 with examples of good cyphers (e.g. in terms of accuracy), examples of poor cyphers, and the like. In some examples, cypher query generation 516 can further include fine-tuning a given structure query, prior to execution, based on or more best practice or constraint provided to the LLM 120. For example, a given structured cypher query can be fine-tuned in terms of efficiency, appropriate alignment, or number of n-hops required to traverse a respective set of nodes or data sources. Examples of structured cypher query tuning and validation are further illustrated and described with respect to FIG. 7.

Multi-hop data retrieval 518 involves executing a structured cypher query to aggregate structured data across two or more data sources. For example, the LLM 120 can be configured to submit a structured cypher query to a graph database in an appropriate graph language such that an aggregated result can be retrieved from the graph database (e.g. in neo4j). In examples, the structured cypher query can be executed, and a result can be obtained from the graph database 400 by the LLM 120. In some examples, the result, query, or both will require further refinement at the error handline 520. An example of graph database 400 and the structured traversal thereof is further illustrated and described with respect to FIG. 4.

In specific implementations, the graph database can be implemented using Neo4j with Cypher as the query language. The large language model can be GPT-40 or similar transformer-based models capable of natural language understanding and code generation. In one tested implementation, the knowledge graph comprised approximately 100,000 nodes and 200,000 relationships representing approximately 20,000 customer orders from a retail fulfillment operation.

Error handling 520 involves the refinement or correction of a given structured cypher query. For example, if, during query execution at multi-hop data retrieval 518, a given structured cypher query returns an error or cannot be completed, an error handling loop can be triggered. In examples, error handling 520 can involve receipt of an error message from the graph database 400, a user, or both. In examples, the LLM 120 can evaluate an error message to correct a given structured cypher query and corresponding retrieval path. In some examples, error handling 520 can further include identifying and correcting cartesian product errors. For example, if a given retrieved result exceeds a predefined threshold, then the LLM can return to the cypher query generation 516 and correct one or more path alignment parameter. In some examples, error handling 520 can further include query-time validation to identify and mitigate execution failures. For example, query-time validation can involve identifying a structured cypher query that exceeds a maximum threshold in terms of the time between cypher query execution and retrieval of a result.

Retrieved data 524 includes an aggregated result obtained from the graph database 400. For example, the retrieved data 524 can include an aggregated result obtained via execution of the structured cypher query across one or more node of the graph database 400. In examples, an aggregated result can correspond to an answer to a given user query. In one example, an aggregated result can directly correspond to a set of requested data which can be provided to the requesting user in structured or non-structured format. For example, the retrieved data can be provided to the requesting user in tabular format. In another example, the retrieved data can be provided to the requesting user as a natural language response.

The user interface 124 is configured to allows an enterprise user to enter a natural language query, display the retrieved data 524, or a combination thereof. For example, aggregated result retrieved from the graph database 400 can be displayed to the enterprise user via the user interface 124. In some examples, the user interface 124 can further be configured to enable a user to provide additional error handling or feedback to the LLM to further refine subsequent cypher query generation, formatting of retrieved data, or a combination thereof.

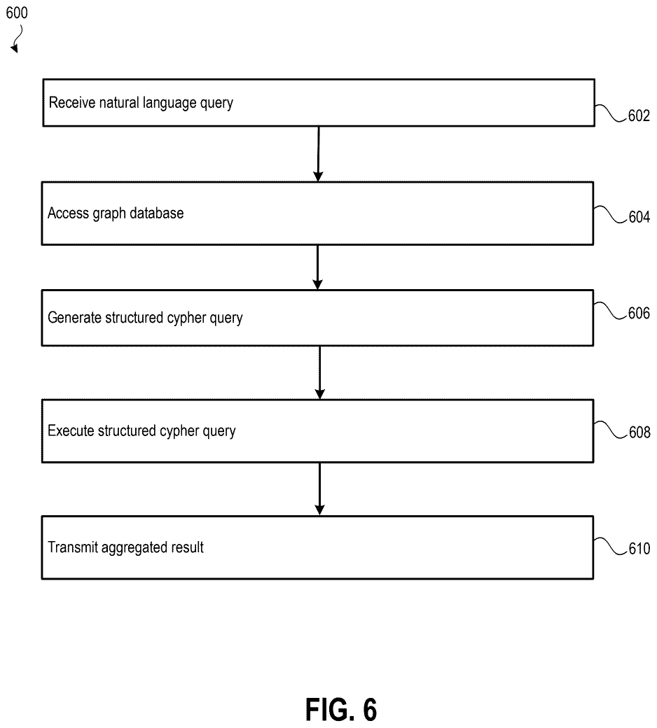

FIG. 6 is a flowchart of an example method 600 for multi-hop retrieval of relational structured data. As described herein, the method 600 is performable LLM 120. However, one or more operations of the method 600 may be performed by a different component of the network environment 100. Furthermore, different subcomponents of the network environment 100 may perform different operations of the method 600.

In the example shown, the LLM 120 may receive a natural language query (step 602). For example, a natural language query can be received from a requesting entity, such as an enterprise user, via a user interface of a computing device. In other examples, the LLM may receive a natural language query from an application executed via an enterprise network, a different LLM, or a combination thereof. Examples of receiving a natural language query are further illustrated and described with respect to FIGS. 1 and 5.

In the example shown, the LLM 120 may access a graph database (step 604). In examples, the graph database can include a plurality of sub-graphs representing a plurality of structured datasets received from a plurality of enterprise data repositories. In examples, a pair of structured data sets can have a hierarchy which must be properly aligned for retrieval of data therebetween (e.g. via a table join). For example, each structured dataset can include one primary key. In examples, each structured data set can further include at least one non-primary key. In some examples, two or more structured data sets can have different data granularities. In further examples, two or more structured datasets can be received from from different data sources. In examples, at least two structured datasets received from two or more different data sources can be unstandardized. In implementations, one or more identifiers included such unstandardized structured datasets may be standardized prior to generating the graph database. In implementations, each sub-graph can include a plurality of nodes, each node defining at least one object within a respective structured dataset. In further implementations, each sub-graph can further include a plurality of edges, each edge defining a linking relationship between two nodes based on a corresponding key between the respective structured datasets. In some implementations, two respective structured datasets may have an interrelated identifier such that a joining edge can define a structured join between the respective structured datasets. In some implementations, two or more structured datasets may include at least one interrelated identifier, wherein each interrelated identifier links the respective structured datasets. In such implementations, a joining edge may represent a structured join between the respective structured datasets. In examples, as further described herein, the plurality of sub-graphs can include a first sub-graph representing a first structured dataset having a first grain and a second sub-graph representing a second structured dataset having a second grain. An example of a graph database 400 is further illustrated and described with respect to FIG. 4.

In the example shown, the LLM 120 may generate a structured cypher query (step 606). For example, a structured cypher query can provide a retrieval path for traversing a subset of nodes within the graph database in a particular order defining a hierarchical alignment between the respective structured datasets. In examples, as further described herein, the structured cypher query can be generated by an ontology-guided LLM. Examples of generating a structured cypher query are further illustrated and described with respect to FIGS. 5 and 7.

In the example shown, the LLM 120 may execute the structured cypher query (step 608). For example, the LLM 120 may execute the structured cypher query to aggregate a result from the graph database 114. In examples, the structured cypher query can be executed to retrieve an aggregated result across subset of nodes within the graph database. In implementations, a given structured cypher query can simulate a multi-hop structured data retrieval scenario, wherein each hop corresponds to a relational join across two structured data sources. For example, a 1-hop query can require one table join across two respective structured data sources. In another example, a 2-hop query can require two tables joins across three respective structured data sources. Examples of executing a structured cypher query are further illustrated and described with respect to FIGS. 4-5.

In the example shown, the LLM 120 transmit an aggregated result (step 610). For example, the LLM can transmit a response to a requesting entity according to the aggregated result. In some examples an aggregated result can be returned as a plurality of values. In examples, the LLM can transmit the aggregated result within a natural language response to the requesting entity. In other examples, the LLM can convert the aggregated into structured data to be provided the requesting entity. For example, the LLM can be configured to convert the aggregated result into structured data according to the defined ontology of the graph database, prior to transmitting the aggregated result to the requesting entity. Examples of transmitting an aggregated result are further illustrated and described with respect to FIGS. 1 and 5.

FIG. 7 is a flowchart of an example method of generating a structured cypher query for multi-hop retrieval of relational structured data using an LLM. As described herein, the method 700 is performable LLM 120. In further embodiments, one or more operations of the method 700 may be performed by a different component of the network environment 100. Furthermore, different subcomponents of the network environment 100 may perform different operations of the method 700. In examples, the method 700 can involve a three-stage query processing pipeline.

First, in an initial generation phase, the LLM can produce ontology-aligned queries based on natural language input. Second, in an ontology correction phase, the LLM can perform identifier correction and relationship mismatch resolution. Third, in an attribute validation phase, the LLM can validate one or more attribute to ensure correct property references. In implementations, the LLM can be provided with training examples including: (1) correctly structured Cypher queries with annotations explaining proper relationship traversal; (2) examples of poorly structured queries demonstrating common errors such as missing constraints or incorrect path specifications; (3) Cypher best practices emphasizing constraint enforcement and hierarchical alignment; (4) ground truth entity and relationship mappings from the ontology; and (5) foreign key and primary key relationship definitions extracted from source data metadata.

As mentioned, in the example shown, the LLM 120 can be configured to produce an ontology-aligned query at an initial query generation phase (step 702). For example, as further discussed herein, the LLM 120 can produce an ontology-aligned, structured cypher query based on a natural language input. For example, the LLM 120 can be configured to receive a natural language request, a defined ontology for a given graph database, metadata defining one or more structured data source, or a combination thereof. In response, the LLM 120 can generate a structured cypher query configured to provide a retrieval path for traversing one or more node within the graph database 114 to obtain an answer to the natural language request. In some examples, the defined ontology for a given graph database enables the LLM 120 to determine a specific, hierarchical relationship between one or more node such that the LLM 120 can generate a structured cypher query configured to obtain precisely aligned retrieval of structured data from the respective node(s). In some implementations, the LLM 120 can further be provided with foreign and primary key relationships between two or more data sources to further enable accurate, aligned structured cypher query generation via the metadata describing the data sources, through natural language prompting, or a combination thereof. In further implementations, the LLM 120 can further be provided with training data including ground truth identifier definitions, data key definitions and relationships, examples of good cyphers (e.g. in terms of accuracy), examples of poor cyphers, and the like.

In some examples, once an initial query is produced, the LLM 120 may further refine the structured cypher query by identifying and correcting any identifier and relationship mismatches at step 704. In other examples, if the LLM 120 is unable to produce an initial structured cypher query or an error is identified upon execution of a given structured cypher query, the LLM 120 may advance to step 704. In some particular implementations, fuzzy matching techniques can be employed to resolve entity name ambiguities. For example, when a natural language query uses informal location terminology (e.g., “Minneapolis store” vs. canonical “Store\_MN\_55401”), the system can apply string similarity algorithms or semantic embeddings to map the informal reference to the correct node identifier in the graph database.

In the example shown, the LLM 120 may identify and correct identifier and relationship mismatches at an ontology correction phase (step 704). In implementations, the LLM 120 can be configured to refine or correct a defined ontology provided to the LLM based on natural language prompting. For example, the LLM 120 can be configured to identify incorrect identifiers within a defined ontology, relationship therebetween, or both by comparison of on or more extracted identifier. In some implementations, the LLM 120 can identify incorrect identifiers or relationships in response to a natural language request or via initiation of an error handling step. In some examples, the LLM 120 can identify incorrect identifiers or relationships based on a comparison of the ontology definition provided to the LLM and training data provided to the LLM 120 at step 702. For example, through use of ground truth identifier definitions, data embeddings, data key definitions, and the like, the LLM 120 can identify and correct one or more identifier within the graph ontology, relationships mismatches between one or more identifier (e.g. improper edge definition), or both. In some embodiments, once an ontology correction phase is completed, the LLM 120 may then further validate property references at an attribute validation phase.

In the example shown, the LLM 120 may validate property references at an attribute validation phase (708). For example, the LLM 120 may be provided with a series of property validation prompts configured to identify and resolve any remaining attribute ambiguities, further refine a structured cypher query approached generated by the LLM 120, or both. For example, the LLM 120 may be configured to iteratively generate and execute one or more structured cypher query and compare the aggregated result to a ground truth. In instances where the given aggregated result is incorrect, then one or more attribute within the knowledge graph ontology (e.g. node, edge, or both) may be further refined. In some instances, where the given aggregated result is incorrect, or still incorrect after future refinement of the knowledge graph ontology, the LLM 120 may be further configured to automatically refine its approach for generating a structured cypher query until the series of property validation prompts are executed with a given threshold accuracy. In examples, the LLM may produce a revised structured cypher query after completion of the attribute validation phase. For example, the revised structured cypher query may then be executed to retrieve an aggregated result from the graph database. In some examples, further refinement may be required based on one or more the aggregated result acquired during the attribute validation phase, an inability to retrieve one or more aggregated result, automated error handling, user input, or the like. The LLM 120 may determine whether to terminate the validation phase at step 708.

In the example shown, the LLM 120 may determine whether to terminate the validation phase (step 708). As mentioned, the LLM may determine whether to terminate the validation phase based on the validation results at step 706. For example, if the validation results at step 706 do not meet a threshold accuracy or exceed a threshold failure rate, then the validation phase may not be terminated. In the example shown, if the validation phase is not terminated, then the LLM 120 may return to step 702. Alternatively, if the validation phase is terminated, then the LLM 120 may proceed to execute the structured cypher query. For example, if the validation results at step 706 meet or exceed a threshold accuracy then the LLM 120 may proceed to execute one or more structured cypher query in response to a requesting entity and transmit the aggregated result(s). An example of executing a structured cypher query is further described with respect to FIG. 6 (step 608).

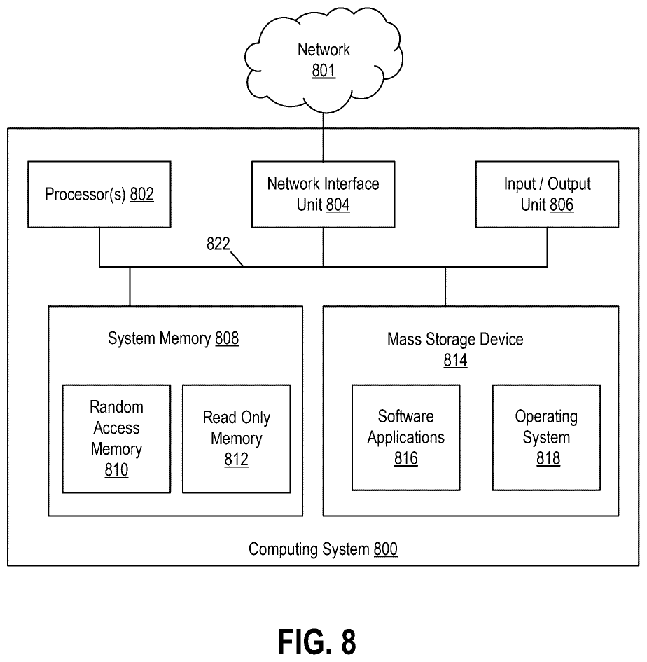

FIG. 8 illustrates an example block diagram of a virtual or physical computing system 800. One or more aspects of the computing system 800 can be used to implement the processes described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 801. The network 801 is a computer network, such as an enterprise intranet and/or the Internet. The network 801 can include a LAN, a Wide Area Network (WAN), the Internet, wireless transmission mediums, wired transmission mediums, other networks, and combinations thereof. The computing system 800 may connect to the network 801 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

With respect to FIGS. 1 and 3-8, generally, techniques of the systems and methods described herein have been empirically evaluated against existing methods, representative of the state of the art on a collection of raw tabular data. As shown in Table 1, the graph database and LLM-based retrieval approach (“GD”) was compared against traditional, hybrid search methods (“Hybrid”). The query complexity in Table 1 is graded based on the number of tables joined and the complexity of the alignment therebetween. Overall, the hybrid search methodology saw a marked decrease in accuracy in increasing query complexity, due to its reliance on keyword matching and embeddings rather than structured joins.

TABLE 1
Graph Database and Ontology-Guided Cypher Generation Vs.
Hybrid Query Performance by Aggregation Complexity

| | GD Acc | Hybrid | GD Gain | |
|---|---|---|---|---|
| Aggregation Type | (%) | Acc (%) | (%) | Explanation |
| Basic Aggregation (No | 79.0% | 76.5% | 2.50% | Aggregation within a |
| Join) | | | | single table, no joins. |
| Retrieving Data from | 44.0% | 1.10% | 42.9% | Aggregation on primary |
| One Related Table | | | | keys of the base-table |
| | | | | after joining one table. |
| Cross-Granularity | 36.5% | 2.70% | 33.8% | Aggregation on non- |
| Aggregation via Single | | | | primary keys of either |
| Join | | | | table after joining one |
| | | | | table, requiring |
| | | | | hierarchical alignment. |
| Cross-Granularity | 32.7% | 3.64% | 29.1% | Aggregation on primary |
| Aggregation on Primary | | | | keys from joined tables, |
| Keys (2 Joins) | | | | requiring two joins to |
| | | | | retrieve grouping keys. |
| Cross-Granularity | 18.0% | 1.00% | 17.0% | Aggregation on non- |
| Aggregation on Non- | | | | primary keys across |
| Primary Keys (2 Joins) | | | | different levels of detail |
| | | | | after joining 2 tables, |
| | | | | requiring hierarchical |
| | | | | alignment. |

As briefly discussed above, Table 1 quantitatively evaluates the performance of the graph database and LLM-based retrieval approach described herein against a state-of-the-art method. Table 1 highlights the ability of the graph data retrieval approach in terms of handling structured, multi-hop retrieval, particularly with increasing query complexity. Unlike traditional hybrid search methods, the graph database approach maintains higher accuracy across all aggregation levels, excelling in hierarchical relationships and structured joins. Its advantage is most evident in cross-table queries, where hybrid search accuracy drops to near-zero (≤3.64%), while the graph database retrieval retains substantially higher accuracy. The largest gain in accuracy (+42.9%) occurs when retrieving data from a related table, while Cross-Granularity Aggregation via a Single Join also shows a significant improvement (+33.8%), highlighting the strength of the graph database in enabling accurate, hierarchical alignment between structured data sources. Even simpler tasks, like single-table aggregation, see a modest increase in accuracy (+2.5%). For two-join queries, the graph database approach maintains increased accuracy (+29.1% and +17.0%, depending on key type), further demonstrating its advantages in terms of structured retrieval.

In particular, the performance evaluation compared the ontology-based knowledge graph approach against a hybrid search baseline. The baseline system stored each row from source tables as a JSON document in Elasticsearch, combining BM25 lexical retrieval with semantic embeddings (e.g., using text-embedding-3-large or similar models). At query time, the LLM was provided with foreign key and primary key relationships to manually link retrieved chunks. The relative weighting between lexical (BM25) and semantic retrieval components was optimized through hyperparameter tuning to maximize baseline performance. This hybrid approach performed adequately on simple single-table queries but degraded significantly on multi-hop queries requiring structured relationship traversal.

Overall, the methods and systems described herein provide advantages relative to existing methods of retrieving structured data. For example, in answering complex queries of structured, relational data, by transforming such data into a graph database having a definable ontology, the system described herein can execute aligned, structured, multi-hop, retrieval therefrom with increased efficiency and accuracy. Furthermore, by providing an automated, three-stage LLM-based query processing pipeline configured to generate and refine ontology-aligned queries and multi-hop retrieval of structured data, efficiency and scalability of the system can be further enhanced. Overall, the structured, relational graph database and ontology-guided LLM cypher generation as described herein enables precise traversal of structured data sources and systematic data aggregation therefrom, thereby facilitating more accurate, faster decision-making in any industry requiring structured, multi-relational data analysis. Advantageously, the methodology described herein can be easily generalized to any structured database having a definable ontology.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of recommendation systems, technologies disclosed herein are applicable to data and methods for validation of recommendations generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computer-implemented method for multi-hop retrieval of structured relational data comprising:
receiving, by one or more processors, a natural language query from a requesting entity;
accessing a graph-based data structure representing a plurality of structured datasets obtained from a plurality of data sources, wherein the graph-based data structure is defined according to an ontology specifying:
a plurality of node types corresponding to structured data entities; and
a plurality of relationship types defining permitted relationships between the node types;
generating, using a machine learning model guided by the ontology, a structured graph traversal query configured to traverse a plurality of nodes of the graph-based data structure according to one or more relationships defined by the ontology;
validating the structured graph traversal query prior to execution;
executing the validated structured graph traversal query against the graph-based data structure to perform a multi-hop traversal across two or more structured datasets and compute an aggregated result;
transmitting, to the requesting entity, a response corresponding to the aggregated result.

2. The computer-implemented method of claim 1, wherein the machine learning model comprises a large language model, and wherein the method further includes providing, to the large language model, the natural language query, a description of the ontology, and metadata describing the plurality of structured datasets.

3. The computer-implemented method of claim 1, wherein validating the structured graph traversal query includes:
detecting at least one of an invalid relationship, an invalid attribute reference, or an unconstrained traversal path that would produce unintended intermediate results; and
modifying the structured graph traversal query to correct the detected condition.

4. The computer-implemented method of claim 3, wherein validating the structured graph traversal query comprises detecting a traversal path that would generate an unintended Cartesian product across multiple structured datasets.

5. The computer-implemented method of claim 4, wherein modifying the structured graph traversal query comprises introducing one or more ontology-defined relationship constraints to eliminate the unintended Cartesian product.

6. The computer-implemented method of claim 1, wherein each hop of the multi-hop traversal corresponds to a relational join traversing a joining edge between a plurality of sub-graphs.

7. The computer-implemented method of claim 6, wherein the plurality of sub-graphs include a first sub-graph representing a first structured dataset having a first grain and a second sub-graph representing a second structured dataset having a second grain.

8. The computer-implemented method of claim 7, wherein the first and second structured datasets are received from two different data sources, wherein the first and second structured datasets are unstandardized, the method further comprising standardizing one or more identifiers included within the first and second structured datasets.

9. The computer-implemented method of claim 7, wherein the first and second structured datasets have at least one interrelated identifier and the plurality of edges includes a joining edge representing a structured join between the first and second structured datasets.

10. The computer-implemented method of claim 1, wherein generating the structured graph traversal query comprises:
generating an initial ontology-aligned query,
correcting one or more entity labels or relationship types that do not conform to the ontology, and
validating one or more attribute references prior to execution.

11. A system for ontology-guided retrieval of structured data, comprising:
one or more processors; and
one or more memory devices storing instructions that, when executed by the one or more processors, cause the system to:
receive a natural language query;
access a graph-based data structure representing a plurality of structured datasets, the graph-based data structure being organized according to an ontology defining entity types, relationship types, and valid traversal constraints;
apply a machine learning model to generate a graph traversal query from the natural language query, the graph traversal query being constrained by the ontology to enforce valid multi-hop relationships between structured datasets; and
execute the graph traversal query to retrieve data spanning multiple structured datasets and to produce an aggregated output.

12. The system of claim 11, wherein the instructions further cause the system to:
perform query validation by analyzing the graph traversal query to identify at least one of:
a relationship mismatch with the ontology,
an invalid property reference, or
an unconstrained traversal path likely to generate incorrect aggregated results; and
revise the graph traversal query prior to execution based on results of the query validation.

13. The system of claim 11, wherein the ontology encodes valid and invalid relationship types between node types.

14. The system of claim 11, wherein the system is configured to prevent execution of a graph traversal query that violates at least one ontology-defined constraint.

15. The system of claim 11, wherein the system is further configured to revise the graph traversal query based on an execution error returned by a graph database engine.

16. The system of claim 11, wherein the plurality of structured datasets are organized into a plurality of sub-graphs including a first sub-graph representing a first structured dataset having a first grain and a second sub-graph representing a second structured dataset having a second grain.

17. The system of claim 16, wherein the first and second structured datasets are received from two different data sources, wherein the first and second structured datasets are unstandardized, the instructions further causing the system to standardize one or more identifiers included within the first and second structured datasets.

18. The system of claim 11, wherein the instructions further cause the system to provide the aggregated output for presentation to a requesting entity.

19. A structured data retrieval system configured to retrieve structured store fulfillment data within a retail enterprise, the system comprising:
a computing system including one or more processors and one or more memory devices storing instructions that, when executed by the one or more processors, cause the computing system to:
receive a natural language query from a requesting entity;
access a graph-based data structure representing a plurality of structured datasets obtained from a plurality of enterprise data sources, wherein the graph-based data structure is organized according to an ontology defining:
entity types corresponding to structured data entities,
relationship types defining permitted relationships between the entity types, and
traversal constraints governing multi-hop traversal across the structured datasets;
generate, using a machine learning model guided by the ontology, a structured graph traversal query configured to traverse a plurality of nodes of the graph-based data structure according to one or more ontology-defined relationships;
validate the structured graph traversal query prior to execution to determine whether the traversal query violates at least one ontology-defined constraint;
modify the structured graph traversal query in response to detecting that the traversal query violates the at least one ontology-defined constraint;
execute the validated structured graph traversal query to perform a multi-hop traversal across two or more structured datasets and compute an aggregated result; and
transmit, to the requesting entity, a response corresponding to the aggregated result.

20. The structured data retrieval system of claim 19,
wherein validating the structured graph traversal query comprises detecting an unconstrained traversal path that would produce an unintended Cartesian product across two or more structured datasets, and wherein modifying the structured graph traversal query comprises introducing one or more ontology-defined traversal constraints to eliminate the Cartesian product.
